(19) United States
(12) Patent Application Publication
(10) Pub. No.: US 2022/0180423 A1
(43) Pub. Date: Jun. 9, 2022

(54) CONFIGURATION ATELIER TABLE FOR INTERACTIVE CUSTOMER EXPERIENCE

(71) Applicant: Polestar Performance AB, Goteborg (SE)

(72) Inventors: Kathrin Bachert, Molndal (SE); Rong Guan, Goteborg (SE); Marcus Olausson, Grabo (SE)

(21) Appl. No.: 17/544,076

(22) Filed: Dec. 7, 2021

Related U.S. Application Data
(60) Provisional application No. 63/122,791, filed on Dec. 8, 2020.

(51) Int. Cl. G06Q 30/06

(52) U.S. Cl. CPC G06Q 30/0643; G06Q 30/0621

(57) ABSTRACT

A configuration atelier table with a display screen and a tile interface and related systems and methods for interactive product configuration. One or more of a plurality of tiles comprising a material sample for a component of the product and a tile ID is placed upon and scanned by the tile interface. The tile ID is mapped to a configuration code and sent to a configurator. The configurator receives one or more configuration codes and generates a representation of a final product incorporating design choices represented by the one or more configuration codes.

### RELATED APPLICATION

This application claims the benefit of U.S. Provisional Application No. 63/122,791 filed Dec. 8, 2020, which is hereby fully incorporated herein by reference.

### TECHNICAL FIELD

Embodiments of the present disclosure relate generally to the field of tables and similar furniture providing enhanced product interaction and purchasing experiences to customers, and more particularly to an interactive atelier table for a place of business that permits interactive configuration and visualization of a customized product to customers and related systems and methods.

### BACKGROUND

As modern consumer preferences shift and move farther away from the industrial age, manufacturing and sales strategies have begun shifting away from models focused on mass production, to ways to create a more customized feel for consumers without fully sacrificing the production advantages of producing similar products by retreating to a made-to-order system. Consumers seeking luxury or otherwise high investment goods, such as cars or houses, are especially interested in seeing a final product that aligns with their individual vision.

Typically, consumers are offered an opportunity to view “models” which demonstrate one possible combination of various design features. Through multiple models a consumer may be able to view each design feature they desire, but it is no assurance that a model exists which is the exact configuration of design choices that a consumer would choose.

This results in situations where a consumer may make a design choice without fully understanding how it will interact with other choices and features resulting in the consumer being ultimately dissatisfied.

A need exists, therefore, for systems and methods to assist consumers in making design choices. A further need exists to increase the interactive experience of consumer product design and close the gap between the uneducated consumer and an experienced designer. A further need exists to assist consumers in accurately envisioning the final design product.

### SUMMARY

Due to the existing system of relying on preconfigured models to assists consumers in making design choices, consumers are often left considering design choices individually and may fail to adequately consider how their design choices will fit together in the final product. Embodiments of the present disclosure provide an improved retail experience for consumers by creating a more interactive product configuration experience. By combining the tactile experience of material samples with the visually satisfying experience of viewing configuration choices in real time, embodiments of the present disclosure create an immersive design experience and allow a consumer to fully visualize a final product incorporating all their design choices. This type of experience and visualization is well-suited for high value products having a variety of features and options amenable to customer preferences, such as a car or vehicle.

In some aspects, the present disclosure is directed to a product configuration system for a retail space. The system comprises a configuration surface with a tile interface, a plurality of tiles comprising a material sample for a component of the product and a tile ID, and a scanner in the tile interface to read the tile ID and transmit the tile ID to a receiver. The receiver receives the tile ID, determines an associated configuration code, and transmits the configuration code to a message handler. The message handler receives the configuration code and transmits the code to a configurator. The configurator receives one or more configuration codes and generates a representation of the product with one or more components comprising a material sample from a selected tile.

An embodiment includes a configuration atelier table for interactive review and customer selection of one or more components of a product. The configuration atelier table includes a support structure, a tabletop portion, a user interface panel, a wireless sensor, a wireless receiver, a message handler, and a near-field communication tag. The tabletop portion is supported by the support structure and includes a configuration surface with uniform frame of planar elongate shape. The user interface panel comprises a display screen and a tile interface. The user interface panel is included on the configuration surface and is accessible by individuals positioned around the configuration surface. The wireless sensor in the tile interface is for reading a wireless identifier of a tile that is user selected. The tile includes a material sample for a component of the product and the wireless identifier. The wireless receiver receives the wireless identifier of the tile and provides a configuration code associated with the wireless identifier. The message handler receives the configuration code from the wireless receiver and transmits the configuration code to a configurator. The near-field communication tag in the tile interface that enables reading out data from the configurator to external wireless devices. The configurator receives the configuration code from the message handler and generates a representation on the display screen of the product depicting the component consistent with the material sample of the tile.

An embodiment includes a configuration atelier table system for interactive review and customer selection of one or more components of a product. The configuration atelier table system includes a configuration surface, a plurality of tiles, a wireless sensor, a wireless receiver, a message handler, and a communications tag. The configuration surface includes a tile interface included on the configuration surface, accessible by individuals positioned around the configuration surface. Each tile of the plurality of tiles comprising a material sample for a component of the product and a wireless identifier. The wireless sensor in the tile interface is for reading the wireless identifier of at least one of the plurality of tiles. The tile is at least one of the plurality of tiles comprising a physical material sample for a component of the product and the wireless identifier. The wireless receiver receives the wireless identifier of the tile and provides a configuration code associated with the wireless identifier. The message handler receives the configuration code from the wireless receiver and transmits the configuration code to a configurator. The communications tag in the tile interface that enables reading out data from the configurator to external wireless devices. The configurator receives the configuration code from the message handler and generates a representation on a display screen of the product depicting the component as the selected material sample.

An embodiment includes a method of configuring a product by a configuration atelier table system for interactive review and customer selection of one or more components of a product. The method includes: receiving, by a receiver, a tile ID for a tile comprising a material sample for a component of the product from a scanner; determining, by the receiver, a configuration code associated with the tile ID; sending, by the receiver, the configuration code to a message handler; receiving, by the message handler, the configuration code; sending, by the message handler, the configuration code to a configurator; receiving, by the configurator, the configuration code; and generating, by the configurator, a representation of the product with the component comprising the material sample. In some embodiments, the method further including: sending, by the configurator, the representation of the product to the message handler; receiving, by the message handler, the representation of the product; and sending, by the message handler, the representation of the product to a remote component.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1A shows an example retail space with a configuration atelier table system, according to an embodiment.

FIG. 1B shows an example of a configuration atelier table including a variety of component samples providing configuration tiles on the configuration surface, according to an embodiment.

FIG. 2A is an example configuration atelier table, according to an embodiment.

FIG. 2B is an example configuration surface, according to an embodiment.

FIG. 2C is an example configuration atelier table, according to an embodiment.

FIG. 2D is an example of a bottom view of components of the configuration atelier table of FIG. 2C, according to an embodiment.

FIG. 2E is a diagram providing an overview of seamless user interactions between the atelier table and a mobile device via NFC tags, according to an embodiment.

FIG. 3A shows material samples for a product in the form of configuration tiles, according to an embodiment.

FIG. 3B shows configuration tiles of a variety of materials that can be used with the configuration atelier table, according to an embodiment.

FIG. 4 is an example integration system for a configuration atelier table system, according to an embodiment.

FIG. 5 is a flowchart of an example method for configuring a product using the disclosed configuration atelier table system, according to an embodiment.

FIG. 6A is another example integration system for a configuration atelier table system, according to an embodiment.

FIG. 6B is a detail view of the example integration system of FIG. 6A, according to an embodiment.

FIG. 7 is an example of hardware and software connections in an example configuration system, according to embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments of the present disclosure add the physical experience of material samples to an otherwise digital interaction of configuring a product. The customer journey becomes seamless and the threshold to a customized final product is lowered by minimizing the necessary interactions to make a configuration or purchase. By using technologies like NFC (Near-field communication) and RFID (Radio-frequency identification) the present disclosure makes a proof-point to be able to handle technology in a sophisticated, surprising way.

Embodiments relate to an interactive product configuration surface for retail spaces, stores, places of business, showrooms, dealerships, convention halls, exhibit/presentation areas, or other sales spaces. Example embodiments discussed herein focus on a system directed to configuration of a vehicle, but the ideas and concepts underlying the present disclosure may be applied to systems for the configuration a variety of products, including but not limited to houses, boats, motorcycles, bicycles, all-terrain vehicles, mobile homes, etc.

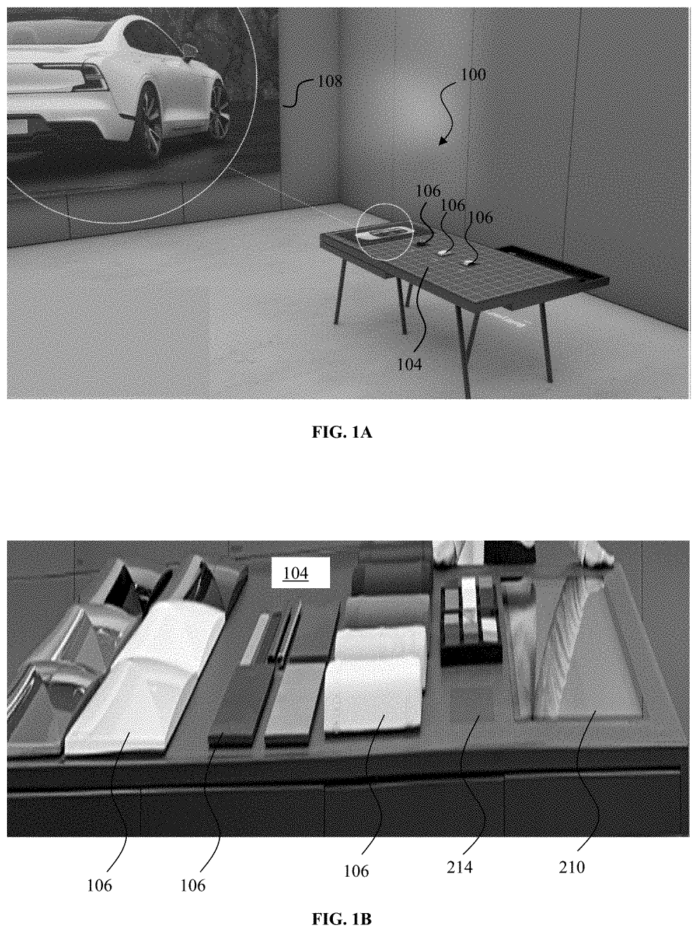

Referring now collectively to FIGS. 1A-3B, a configuration atelier table system 100 is depicted according to embodiments of the present disclosure. At times throughout this disclosure the configuration atelier table system 100 may alternatively and interchangeably referred to as a “product configuration system” as well and should be broadly understood to encompass these terms. In various embodiments, the configuration atelier table system 100 can include a configuration atelier table 104, a plurality of diverse configuration tiles 106, and a remote component 108.

Configuration atelier table 104 can include a support structure 202 and a tabletop portion 204. Configuration atelier table 104 should be broadly construed to encompass a variety of tables and similar furniture items, such as cabinets or counters for example. Support structure 202 may include one or more legs, panels or other structure that supports tabletop portion 204 such that it is elevated from the floor and lying in a horizontal plane at a height convenient to users. Tabletop portion 204 is supported by the support structure 202 and generally comprises a configuration surface 206. In some embodiments, the configuration surface 206 is planar, elongate and rectangular in shape. Other shapes (circles, oval, squares, irregular etc.) for the tabletop portion 204 are contemplated as well. The configuration surface 206 can be generally covered by a rubber mat with a grid pattern. In some embodiments, the rubber surface includes an enamel paint surface. The configuration surface 206 can serve as a durable work surface upon which to put material and configuration tiles 106 providing component samples. Configuration surface 206 may be sized to occupy to the full surface area of configuration atelier table 104.

In embodiments, the tabletop portion 204 below configuration surface 206 may provide additional space for storage of configuration tiles 106 including additional samples, such as seen in the example configuration surface depicted in FIG. 1B. For purposes of this disclosure, all low profile squares or shapes of material finishes, miniature samples, as well as larger material samples will be referred to as configuration tiles 106 or tiles 106. The concept of a configuration tile should be broadly interpreted to encompass all types of samples for a product's components. For example, in an instance where the product is an automotive vehicle, the tiles 106 may each represent samples of a plurality of options for the interior or exterior of the automotive vehicle. This could include stitching patterns for upholstery, interior hardware finishes, external paint color, rim type and many other configuration options.

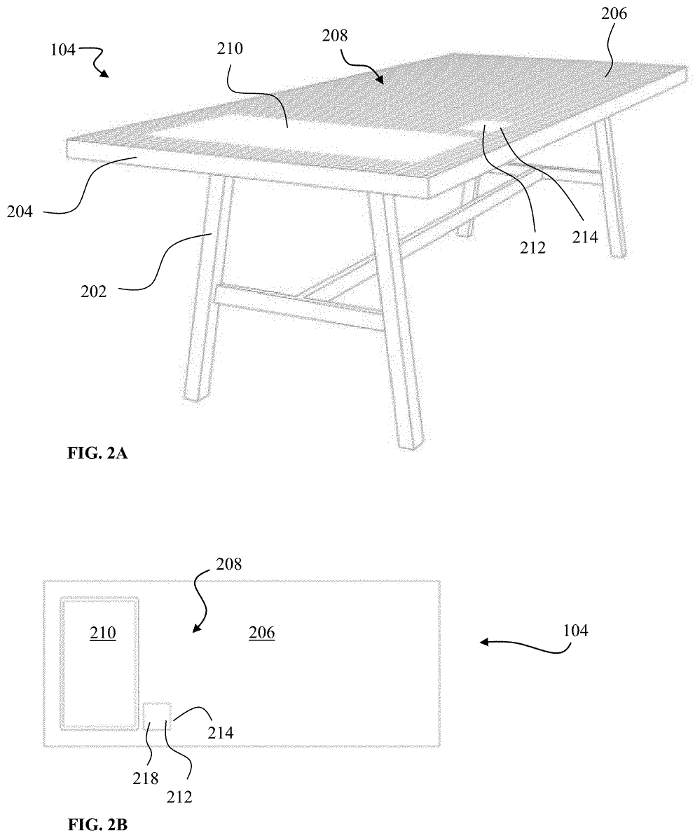

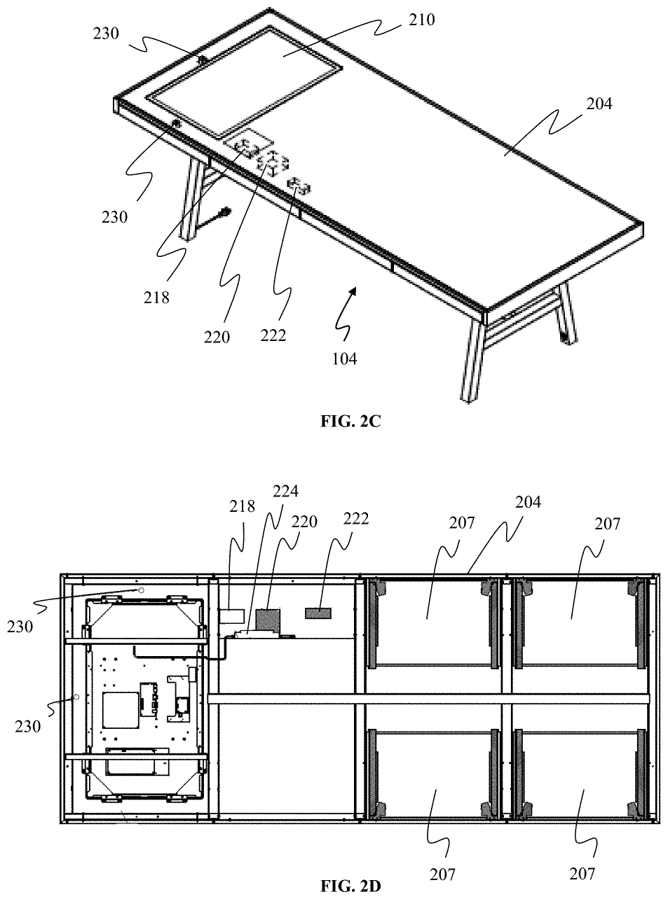

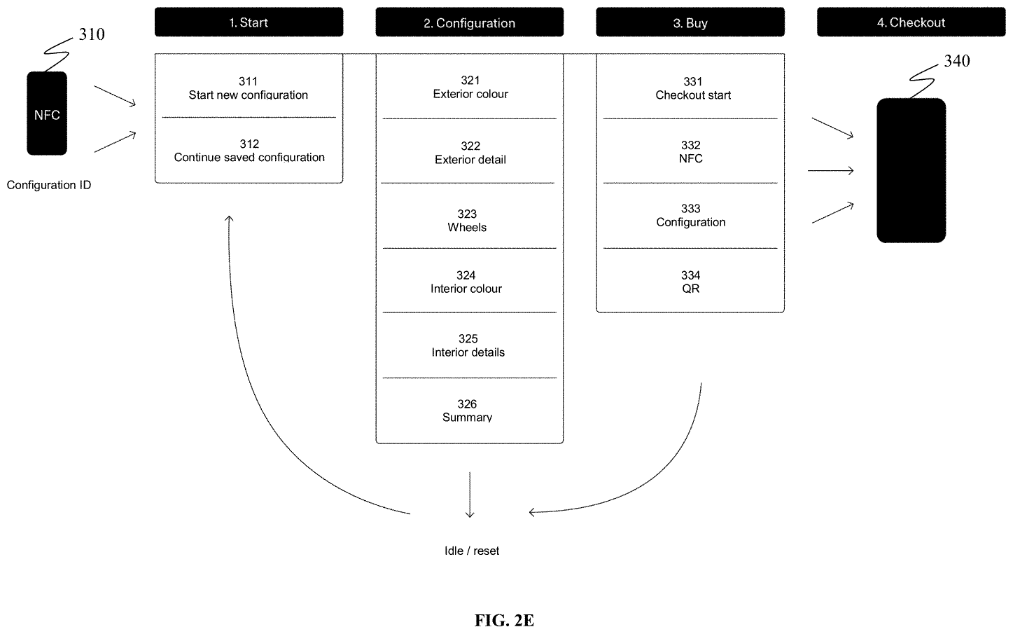

In embodiments, configuration tiles 106 of various sizes and shapes may be stored somewhere other than the tabletop portion 106 and its configuration surface 206, and may be selectively brought out when a consumer expresses interest in a particular feature. In some embodiments, configuration atelier table 104 may further comprise storage for configuration tiles 106. For example, drawers or cabinets may be incorporated in the underside of the tabletop portion 204 of configuration atelier table 104. In some embodiments, the additional space may include two drawers 207 that can extend outwardly from each side of the elongate sides of the table. See the drawer locations in FIG. 2D for example.

Included on the configuration surface 206 is a user interface panel 208. The user interface panel 208 includes a display screen 210 and a tile interface 212.

In some embodiments, user interface panel 208 may be understood to be largely limited to the area occupied by display screen 210 and tile interface 212.

Display screen 210 provides a display incorporating the design features indicated by the user's design selections. As a consumer or user indicates design choices by placing sample tiles 106 on a tile interface 212, an example final product may be displayed on the display screen 210, incorporating the indicated design features received from the tile interface 212. In embodiments, display screen 210 may have diverse functionality, and play a role in a consumer's selection and potential purchase beyond presenting an example final product. Display screen 210 may be a touch screen and allow for user inputs via touch. In some embodiments, tile interface 212 may be integrated with display screen 210. In some embodiments, the display screen 210 may be independently configured for other uses or otherwise networked with a purchase system, an inventory management system, etc.

It should further be understood that user interface panel 208 including display screen 210 and tile interface 212 are part of an overall user interface for the system. The user interface can receive user inputs and provide user outputs regarding configuration of configuration atelier table system 100 and status of a cloud infrastructure, in some embodiments. User interface can comprise a mobile application, web-based application, or any other executable application framework. User interface can reside on, be presented on, or be accessed by any computing devices capable of communicating with the various components of system 100. The user interface can receive user input, and present outputs to the user. In certain preferred embodiments, the user interface may be integrated or contiguous with a design surface structure, such as the configuration atelier table 104. In some embodiments, user interface can reside or be presented on a smartphone, a tablet computer, laptop computer, or desktop computer.

FIGS. 2C and 2D further depict an example configuration atelier table 104 and a bottom view of components of the configuration atelier table 104, respectively. In these figures, an RFID scanner/reader 218, computing system 220, power supply 222, and socket 224 are shown. Specifically, RFID scanner/reader 218 is shown directly adjacent the lower right corner of display screen 210 such that it is at the right hand location of a user standing in front of the display screen 210, such that intuitive access to the RFID scanner/reader 218 is provided.

In various embodiments, the perimeter can contain a perimeter frame around the configuration surface that is uniform in that it is generally the same on both opposing sides. In certain embodiments the orientation of the display screen 210 and corresponding RFID scanner/reader 218 and related components can be placed at an opposite orientation and location with respect to the right and left end of the table.

In some preferred embodiments, the user interface for configuration atelier table system 100 can permit seamless user interaction between a mobile device or other wireless computing device running an app and the configuration atelier table 104. For example, a user's phone may exchange user data with the user interface panel when it is in close proximity to the configuration atelier table via NFC. This way the user can save and follow along with product configurations made by a user via the configuration atelier table 104. At any time, the user can discontinue interfacing with the configuration atelier table and save progress to the user's phone. Further, if a user is ready to complete a purchase of a custom configuration completed for the product, the app on the user's phone can obtain the custom configuration and allow the user to make a purchase of the product via the app.

In FIG. 2D, two NFC tags 230 are shown in the configuration atelier table 104, allowing the configuration atelier table system 100 to be NFC-interaction enabled. One is directly below the display screen 210 in at a location directly in front of a use, and the other is at the side of the display screen 210 at the end of the table. A diagram providing an overview of the seamless user interaction between the atelier table and a wireless mobile device via NFC tags is located in FIG. 2E. As can be understood in further detail here, by equipping the atelier table 104 with NFC tags 230, the user is able to read in a previously done configuration and do a similar interaction to the QR code functionality and read out the configuration done on the tabletop configurator in-store. This provides a customer experience that is seamless.

For example, as shown in FIG. 2E, an NFC tag 230 connects with the wireless device 310 shown such that progressing through the configuration steps can take place or be resumed in a store having a table. In general, visitors that are ready to mock up how their own version of a Polestar car would look like are invited to do so at atelier table. 104 The visitor user will be able to either start from scratch or pick up where he or she left off on earlier on another device. Likewise if the user wants to complete the purchase, they will do so by bridging over to their own mobile device.

Based on a configuration ID, a user can progress through the steps by first starting a new configuration at 311 or continuing a saved configuration at 312. Next configuration decisions can be made related to features such as exterior color 321, exterior details 322, wheels 323, interior color 324, interior details 325, and summary 326. Next, a user can progress to the buying stage including starting checkout at 331, NFC operations 332, configuration ID 333, and QR 334. Finally, checkout is completed at 340.

NFC integration is made possible as tabletop to wireless device support is in place in configurator APIs. Local settings are used to define a table ID. As configuration changes are made, the configurator posts a table ID and current configuration state to the API. An NFC tag/chip is programmed with a fixed URL including the table ID. When the user scans the NFC tag, the configuration is loaded from the table specific URL and the user is redirected to a deep link for the configuration state.

Additional screen or displays, such as remote component 108, may also be in communication with the system and provide additional visualization of configured products. Remote component 108 may directly reflect the content of display screen 210 or remote component 108 may be independent of the display screen 210. For example, remote component 108 may be used to display different views of the configured product or provide recommendations for additional features to the user while display screen 210 displays the current configuration. In embodiments, remote component 108 may be absent from the system 100.

Tile interface 212 enables a user to indicate desired design features by placing selected sample tiles 106 on the tile interface 212. The size of tile interface 212 is variable, and in some embodiments, may occupy as much as all of configuration surface 206. The size of tile interface 212 may be determined according to the size of configuration tiles 106 and the number of available variables. For example, in a system designed for vehicle configuration, sample tiles may fall into four categories for exterior body color, interior color, rims, and brightworks. In some embodiments, tile interface 212 may accordingly be sized to accommodate four sample tiles 106 to allow a user to explore the full range of options. In various embodiments, a boundary indicator 214 is present on the configuration surface 206 identifying the location in which configuration tiles 106 must be placed for their wireless identifier 406 to be wirelessly read by a RFID scanner or other wireless sensor 218. The boundary indicator 214 may be a perimeter line, a solid surface pattern or a different surface pattern, a raised or a recessed portion of the configuration surface, a textured area, or other type of indicator.

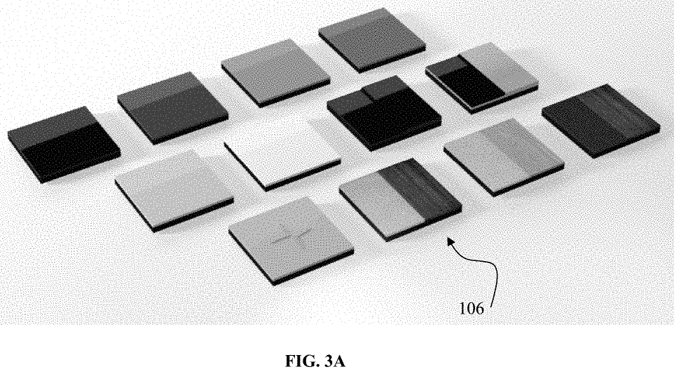

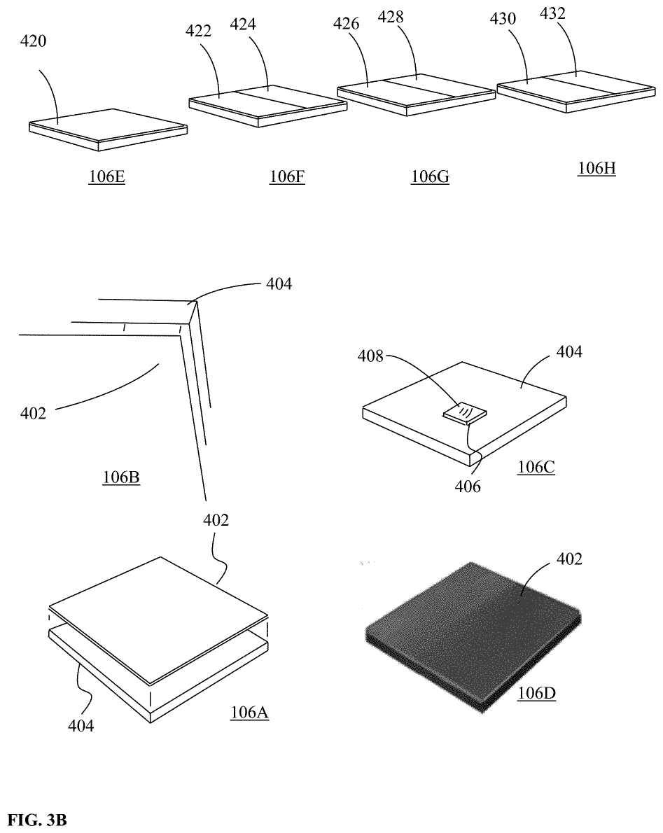

Configuration tiles 106 provide a user an interactive means of using samples to indicate design choices. In FIG. 3B, a variety of configuration tiles 106 or parts thereof are shown (more specifically referred to by reference numerals 106A-H). Each of sample tiles 106 may comprise a physical sample material 402 affixed to a base plate 404 and further providing wireless identifier 408 supplying a feature configuration code 406. As mentioned previously, all low profile squares or shapes of material finishes, miniature samples, as well as larger material samples will be encompassed within the identifier of tiles 106. The concept of a configuration tile 106 as well as corresponding physical samples 402 should be broadly interpreted to encompass all types of samples for a product's components.

Physical sample material 402 can provide a consumer a physical interactive example of design feature. The examples presented herein depicts physical sample 402 as square samples, but other shapes are envisioned. In embodiments, physical sample 402 may be circular, triangular, etc. and may incorporate three-dimensional topographic details of the represented feature. In embodiments, the physical sample may be a miniaturized or otherwise appropriate example of the full feature or may only provide a portion of the feature.

For example, in a system arranged for vehicle configuration, a sample tile for the vehicle rims may be round and incorporate the ridges and depressions of the rim design. A rim sample may be a miniature of the full rim design or, especially in the case of repeating designs, may only show a portion of the overall pattern. Sample tiles for interior and exterior colors may be designed for a consumer to receive the overall experience. For example, an exterior color sample tile may incorporate a ridge or bend, to allow any color shifts in the body color to be visible. An interior color sample may include stitching and any contrast color incorporated.

In FIG. 3B, variations of a physical sample material 402 and a base plate 404 are shown in assembled, separate, and exploded views of configuration tiles 106A-D. For tile 106E, the tile is indicative of the exterior of a vehicle, and specifically provides a color sample 420. Tile 106F represents an interior sample of a vehicle and includes a leather sample 422 on one side and an aluminum carbide sample 424 on the other, Tile 106G represents a sample of the vehicle rims, with a glossy black sample 426 and an aluminum carbide sample 428. Tile 106h represents brightworks and has a first side 430 with glossy black chrome and a second side 432 with the base plate exposed.

Base plate 404 may comprise any appropriate material for mounting the physical sample 402 and may be selected for other desired character, such as being non-skid, non-marking, lightweight/heavy, etc. The example presented herein depicts base plate 404 with the same dimensions as physical sample 402, but other dimensions are envisioned. In embodiments, the dimensions of base plate 404 may be such that base plate 404 protrudes from underneath physical sample 402 on one or more sides. In embodiments, base plate 404 may be excluded entirely.

Feature configuration code 406 may be affixed to base plate 404 or base plate 404 may further comprise an aperture through which the code is read or viewed. Code 406 may be any appropriate scannable code such as a barcode, QR code, etc. In some embodiments, the QR code may be adjustable in terms of right, center, or right orientation within the application of the screen. In certain preferred embodiments, configuration code 406 may be embodied in an RFID tag as a wireless identifier 408 and tile interface 212 may comprise an RFID scanner as a wireless sensor 218. In embodiments, feature configuration code 406 may be absent and the tile interface may otherwise identify the indicated design feature, such as through visual analysis.

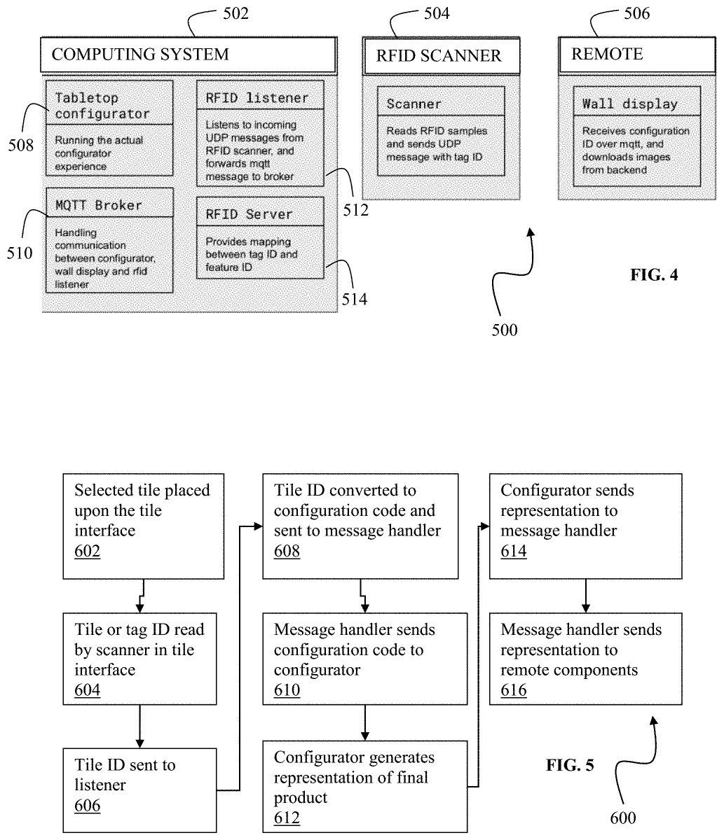

Referring now to FIG. 4, a block diagram of an example integration system 500 for the operation of configuration atelier table system 100 is shown. Integration system 500 may comprise a computing system 502, a scanner 504, and remote component 506. The example presented in system 500 uses a RFID scanner 504 by example, presuming a system using RFID tags for feature configuration code 406, but any known or appropriate scanning system may be used, including but not limited to barcode scanners, QR code scanners, etc.

Computing system 502 may generally comprise any known computing form factor, but in certain preferred embodiments may comprise a small form factor for a lower profile integration with configuration atelier table 104. Computing system 502 stores, operates, and integrates the various components and instructions for the operation of the configuration atelier table system. Computing system 502 may comprise any number components or instructions depending on the desired features of the configuration atelier table system, but in example system 502 comprises tabletop configurator 508, message handler 510, RFID listener 512, and RFID server 514.

Tabletop configurator 508 runs the overall product configuration experience, receiving messages indicating design choices from the message handler 510 and generating a representation of a final product incorporating the design choices and presenting the representation on a screen, or other user interface. In various embodiments, the tabletop configurator 508 and/or configurator discussed may be considered a configurator engine.

Message handler 510 handles communications between configurator 508, listener 512, and remote component 506. In this example system, integration system 500 uses Message Queuing Telemetry Transport (MQTT) protocol for system communications, so message handler 510 is exemplified by an MQTT broker. Different embodiments may use different messaging protocols, and message handler 510 may differ from an MQTT broker accordingly. Any message-oriented middleware (MOM) that supports sending and receiving messages between distributed systems may be readily substituted for or provided in addition to MQTT, to support or supplement the message protocol system. MOM communication may be generally preferred because it allows software components (applications, Enterprise JavaBeans, servlets, and other components) that have been developed independently and that run on different networked platforms to interact with one another. Other communication protocols which provide integration of diverse components may also be used.

RFID listener 512 receives messages from scanner 504 and communicates them to the MQTT broker 510. In embodiments, like this example, where scanner 504 sends messages in a different protocol (UDP) than computing system's 502 primary protocol (MQTT) RFID listener 512 may convert the message to the appropriate protocol before sending.

RFID server 514 provides mapping between a tag ID, or configuration code 406, and a feature ID for integrating with a configured product displayed on the screen.

Scanner 504 may generally comprise the tile interface 306. Scanner 504 reads a configuration code 406 when an associated tile 106 is placed on the tile interface 306 and sends a message to computing system 502 with the configuration code 406 or tag ID. The example presented in FIG. 4 uses a user datagram protocol (UDP) to transmit messages to the computing system 502, but any effective wireless communication protocol may be used. In embodiments with the scanner 504 in close proximity to computing system 502, wired communication protocol may also be used.

Remote component 506 receives messages from message handler 510 and provides remote functionality for the configuration atelier table system. In this example, the remote component 506 is a wall display, such as remote component 108 in FIG. 1A. Remote components may be configured with their own independent computing system which communicates with the primary configurator computing system 502. For example, a wall display may comprise a “smart” screen with an integrated processor, memory, etc. or may have its own small form factor in communication with and operating the screen, such as through an HDMI port. Remote components may provide for a more immersive product configuration experience, and may be varied according the product being configured and the retail space. The present example uses a single wall display to present a user with a larger image of a configured product, but other remote components are envisioned. For example, wall displays could be provided across all four walls of a square or rectangular space, and provide different views of an interior space to give a consumer complete experience of that space. Other remote components such as haptics, three-dimensions or augmented reality viewing, scent or temperature control, etc. may be integrated according to the desired retail experience.

Referring now to FIG. 5, a flowchart of an example method 600 of using the configuration atelier table system disclosed herein is shown, according to embodiments of the present disclosure.

Embodiments of the present disclosure may be directed to methods for the use of configuration atelier table system disclosed herein. It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

A tile representing a selected design feature is placed on the tile interface 602 and the configuration code is read by the scanner in the interface 604. The scanned tile ID or configuration code is sent to the listener 606 and converts the protocol of the received message is necessary. In embodiments, the listener may also communicate with an RFID server to map the received tile ID to an appropriate configuration code for utilization by the configurator. The listener transmits the appropriate configuration code to the message handler 608. The message handler sends the configuration codes to the configurator 610. The configurator generates a representation of a final product incorporating the selected design feature 612 and sends the representation of the final product to the message handler 614. The message handler sends the representation to any appropriate remote components 616.

Additional configuration may occur at remote components as necessary. For example, if a remote component is a display that presents an alternative view of the configured product, appropriate processing may occur at the remote component itself.

The method may be repeated iteratively or in parallel. For instance, in embodiments with a tile interface sized to receive multiple tiles at once, the method may be executed multiple times in parallel for each selected tile, such that the representation of the final produce produced by the configurator incorporates multiple design features. In an example using configuration of a vehicle, tiles for each of the exterior, interior, rims, and brightworks may be selected, and a final vehicle configuration with the all of the selected features presented. Tiles may be changed by the user one at a time, all at once, or anywhere in between. The system may be configured to reconfigure the represented product automatically when a tile is changed, such as configuring the scanner to detect when tile is changed or run periodically. The system may be configured to reconfigure the represented product only when directed by a user, such as by a button or a voice command, so that a user may view a previous configuration while making design selections for a next configuration.

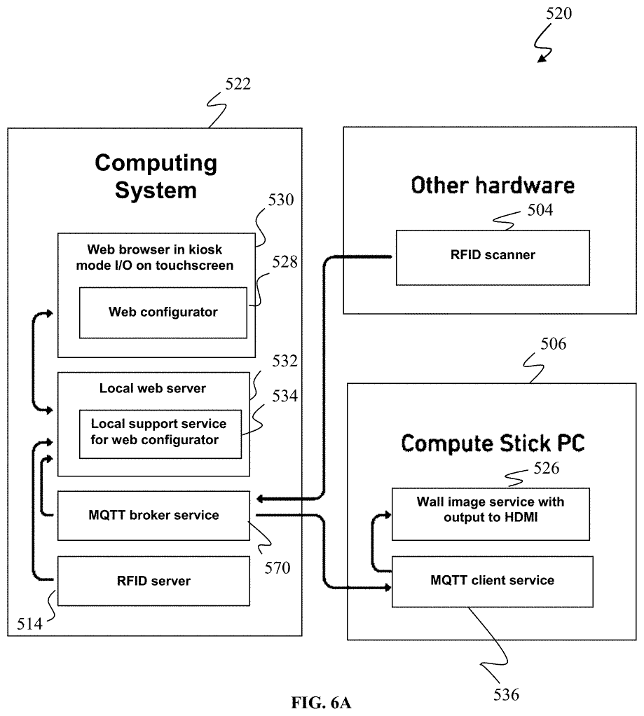

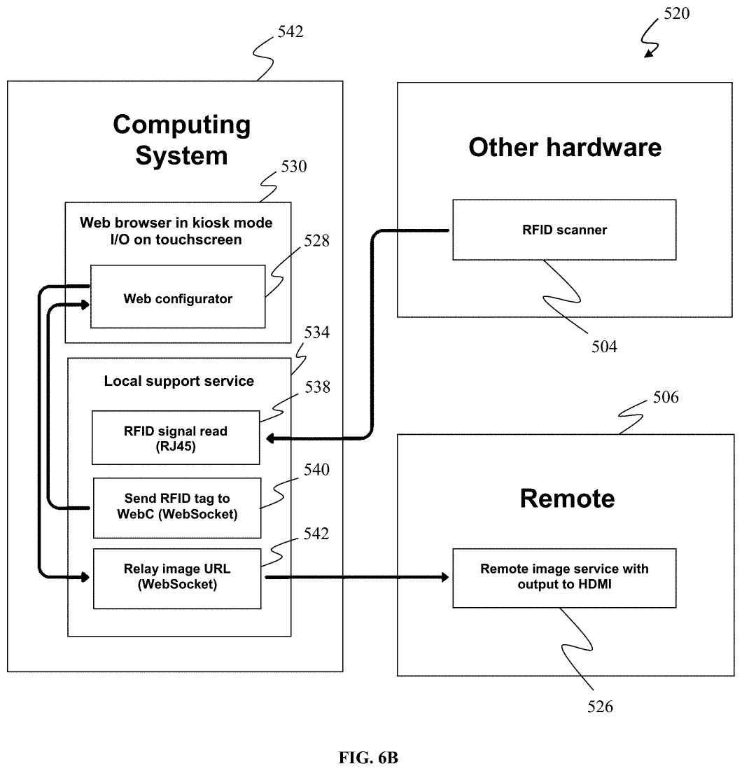

Referring now to FIGS. 6A and 6B, a block diagram of another example integration system 520 for the operation of configuration atelier table system 100 is shown. Integration system 520 may comprise a computing system 522, a scanner 504, and remote component 506. The example presented in system 520 uses a RFID scanner 504 by example, and a compute stick PC 506 as remote component 506. RFID scanner 504 may function substantially the same as described above in relation to example system 500 of FIG. 4.

Remote component 506 comprises a wall image service 526, substantially similar to the remote component 506 of example system 500 of FIG. 4.

Remote component 506 may further comprise a MQTT client service 536, or other message library or remote communication message-handling unit, depending on the messaging protocol employed. Client service 536 may provide for communication between the remote component 506 and the central computing system 522. Client service 536 may further provide for relaying of messages to other remote components, such as a wall display.

Example computing system 522 may comprise a message handler 510, an RFID scanner 514, a web browser 530, and a local web server 532.

Message handler 510, such as the example message handler of a MQTT broker shown in example system 520, may be substantially the same as message broker 510 described above in relation to example system 500 of FIG. 4.

RFID scanner 514 may be substantially the same as RFID scanner 514 described above in relation to example system 500 of FIG. 4.

Web browser 530 may comprise a web configurator 528.

Web browser 530 may be any known or developed software application for accessing information on the Internet. In embodiments, web browser 530 may instead be another browser or access application for accessing information on other networks besides the Internet.

Web configurator 528 may be a web application or a website and may provide a user a substantially similar experience as described in reference to tabletop configurator 508, of example system 500 in FIG. 4, described above.

Local web server 532 may comprise support service 534.

Web server 532 may be any server software, hardware dedicated to running server software, or some combination of software and hardware, configured to handle network requests. In embodiments, server 532 may comprise one or more websites or applications, such as web configurator 528.

Support service 534 may generally represent services provided by server 532. Such services may include various communication relays and message protocol handling.

For example, support service 534 may include receiving the RFID signal 538 from a RFID scanner 504, such as through a physical connection. Example system 520 provides an RJ45 jack for connection to the RFID scanner 504 and receiving RFID signals 538.

Support service 534 may comprise one or more web sockets 540, 542 for communication to (web socket 540) and from (web socket 542) web configurator 528. For example, a received RFID signal 538 may be send to web configurator 528 via web socket 540 for integration with an ongoing configuration. This current configuration may be received by support service 538 by web socket 542. The current configuration may also be communicated to a remote component, such as well display 526, such as via web socket 542.

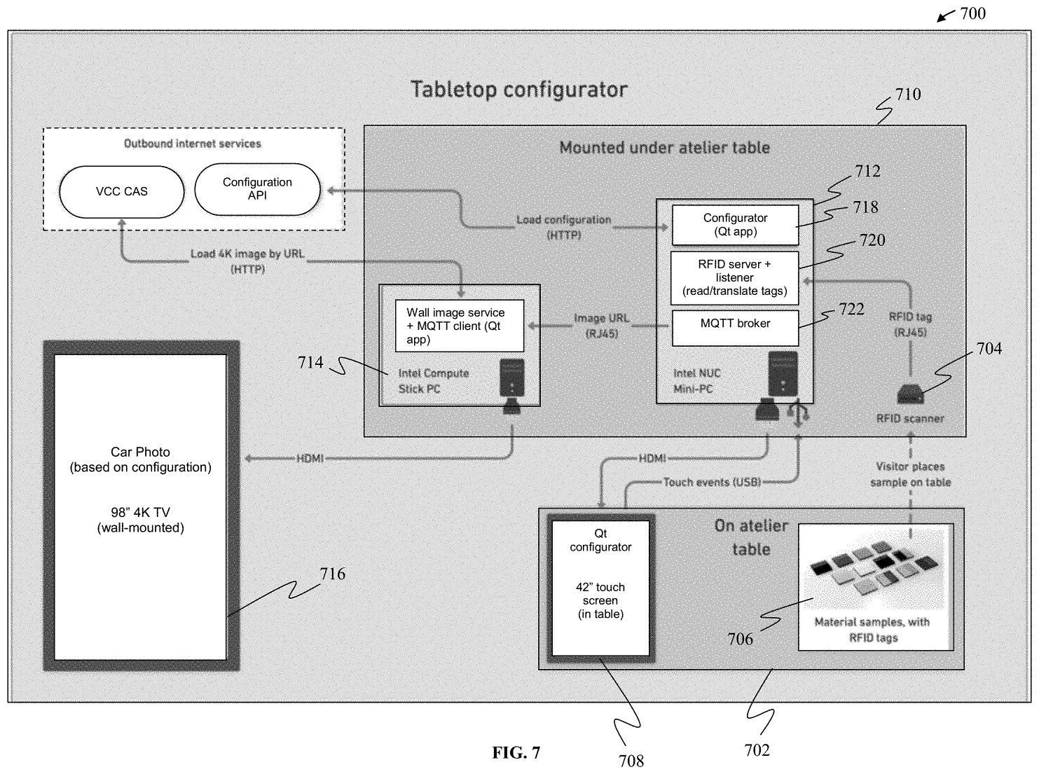

Referring now to FIG. 7, an example overall configuration system 700 is shown, according to embodiments of the present disclosure. Configuration system 700 may generally comprise an interface surface 702, an underside of interface surface 710, and remote display 716.

Interface surface 702 may generally comprise a configurator screen 708 and one or more sample tiles 706. Configurator screen 708 may provide a user with an interactive configuration view, which updates according to user's current sample tile 706 selection. Interface surface 702 interacts with various components integrated with the underside of interface surface 710, such as RFID scanner 704, computing system 712, and remote computing system 714. Computing system 712 may comprise a configurator application 718, RFID server 720, and message broker 722.

RFID scanner 704 reads RFID tags on sample tiles 706 place on interface surface 702 and RFID server 720 interprets the read RFID tag to determine the appropriate configuration changes. RFID server 720 may also communicate with other components of computing system 712. For example, configurator application 718 may receive determining configuration changes from RFID server 720 and integrate them into the current configuration and provide for display of the current configuration on configuration screen 708. Message broker 722 may communicate with remote computing system 714 to provide for coordination of various current configuration displays. In some embodiments, a local cache of pictures and configurations will be present in the configuration system 700.

Remote computing system 714 may comprise a message client and provide for communicating current configuration display information to remote display 716. Remote display 716 may generally reflect the current configuration of configuration screen 708.

In one embodiment, the system 100 and/or its components or subsystems can include computing devices, microprocessors, modules and other computer or computing devices, which can be any programmable device that accepts digital data as input, is configured to process the input according to instructions or algorithms and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. 112(f) are not to be invoked unless the specific terms “means for” or “step for” are recited in a claim.

What is claimed is:

1. A configuration atelier table for interactive review and customer selection of one or more components of a product comprising:
a support structure; and
a tabletop portion, supported by the support structure, including a configuration surface with uniform frame of planar elongate shape;
a user interface panel, comprising a display screen and a tile interface, included on the configuration surface and accessible by individuals positioned around the configuration surface;
a wireless sensor in the tile interface for reading a wireless identifier of a tile that is user selected, the tile comprising a material sample for a component of the product and the wireless identifier;
a wireless receiver that receives the wireless identifier of the tile and provides a configuration code associated with the wireless identifier;
a message handler that receives the configuration code from the wireless receiver and transmits the configuration code to a configurator;
a near-field communication tag in the tile interface that enables reading out data from the configurator to external wireless devices; and
wherein the configurator receives the configuration code from the message handler and generates a representation on the display screen of the product depicting the component consistent with the material sample of the tile.

2. The configuration atelier table of claim 1, wherein a boundary indicator is present on the configuration surface that identifies a specific location in which the tile is placed for the wireless sensor to read the wireless identifier.

3. The configuration atelier table of claim 2, wherein the wireless sensor reads the wireless identifier for each of a plurality of tiles within the boundary indicator.

4. The configuration atelier table of claim 1, wherein the wireless sensor is an RFID reader.

5. The configuration atelier table of claim 1, wherein the near-field communication tag is one of a plurality of near-field communication devices present in the tile interface.

6. The configuration atelier table of claim 1, wherein the product is an automotive vehicle and the tile comprises one of a plurality of options for the interior or exterior of the automotive vehicle.

7. The configuration atelier table of claim 1, wherein the representation is further displayed on a second display screen not located within the tabletop portion of the configuration atelier table.

8. The configuration atelier table of claim 1, wherein the configuration surface includes a gridded, rubber surface and enamel paint finish.

9. The configuration atelier table of claim 1, wherein the support structure includes a plurality of leg supports.

10. A configuration atelier table system for interactive review and customer selection of one or more components of a product comprising:
a configuration surface comprising an tile interface included on the configuration surface, accessible by individuals positioned around the configuration surface;
a plurality of tiles, each tile comprising a material sample for a component of the product and a wireless identifier;
a wireless sensor in the tile interface for reading the wireless identifier of at least one of the plurality of tiles, the tile being at least one of the plurality of tiles comprising a physical material sample for a component of the product and the wireless identifier;
a wireless receiver that receives the wireless identifier of the tile and provides a configuration code associated with the wireless identifier;
a message handler that receives the configuration code from the wireless receiver and transmits the configuration code to a configurator;
a communications tag in the tile interface that enables reading out data from the configurator to external wireless devices; and
wherein the configurator receives the configuration code from the message handler and generates a representation on a display screen of the product depicting the component as the selected material sample.

11. The configuration atelier table system of claim 10, wherein the display screen is remote from the configuration surface.

12. The configuration atelier table system of claim 10, wherein the display screen is included on the configuration surface.

13. The configuration atelier table system of claim 10, wherein the message handler transmits the configuration code using a Message Queuing Telemetry Transport (MQTT) broker.

14. The configuration atelier table system of claim 10, wherein a boundary indicator is present on the configuration surface that identifies a specific location in which the tile is placed for the wireless sensor to read the wireless identifier.

15. The configuration atelier table system of claim 10, wherein the communications tag uses near-field communications.

16. The configuration atelier table system of claim 10, wherein the wireless sensor is an RFID reader.

17. A method of configuring a product by a configuration atelier table system for interactive review and customer selection of one or more components of a product, comprising:
receiving, by a receiver, a tile ID for a tile comprising a material sample for a component of the product from a scanner;
determining, by the receiver, a configuration code associated with the tile ID;
sending, by the receiver, the configuration code to a message handler;
receiving, by the message handler, the configuration code;
sending, by the message handler, the configuration code to a configurator;
receiving, by the configurator, the configuration code;
generating, by the configurator, a representation of the product with the component comprising the material sample.

18. The method of claim 17, further comprising:
sending, by the configurator, the representation of the product to the message handler;
receiving, by the message handler, the representation of the product;
sending, by the message handler, the representation of the product to a remote component.

19. The method of claim 17, wherein the product is an automotive vehicle and the tile comprises one of a plurality of options for the interior or exterior of the automotive vehicle.
